(19) United States
(12) Patent Application Publication
(10) Pub. No.: US 2014/0019950 A1
(43) Pub. Date: Jan. 16, 2014

(54) INFORMATION PROCESSING APPARATUS AND METHOD FOR DETERMINING WHETHER A MODIFIED PROGRAM IS TO BE APPLIED

(71) Applicant: FUJITSU LIMITED, Kawasaki-shi (JP)

(72) Inventors: Yukinobu OHMURA, Kawasaki (JP); Tetsuya SHINBOKU, Kawasaki (JP); Akitoshi OZAWA, Zushi (JP)

(73) Assignee: FUJITSU LIMITED, Kawasaki-shi (JP)

(21) Appl. No.: 14/032,573

(22) Filed: Sep. 20, 2013

Related U.S. Application Data
(63) Continuation of application No. PCT/JP2011/056853, filed on Mar. 22, 2011.

(51) Int. Cl. G06F 9/445

(52) U.S. Cl. CPC G06F 8/65
USPC 717/168

(57) ABSTRACT

An information processing apparatus includes a check data applicator, a count-up determiner, and a patch data applicator. When there is a modified part in a computer program under operation and the modified part has been executed, the check data applicator applies check data incorporating processing of counting the number of times the modified part has been executed to the program under operation. The count-up determiner determines if the count indicating the number of times the modified part has been executed is counted up at a predetermined timing as a result that the check data has been applied. When the count has been determined to be counted up, the patch data applicator replaces the check data including the modified part determined to be counted up with a post-modification program including the modified part having been modified. The configuration described above enables appropriate determination whether the post-modification program is to be applied.

### CROSS-REFERENCE TO RELATED APPLICATION

This application is a continuation of International Application No. PCT/JP2011/056853, filed on Mar. 22, 2011, the entire contents of which are incorporated herein by reference.

### FIELD

The embodiment discussed herein is related to an information processing apparatus and other apparatuses.

### BACKGROUND

In recent years, patches of computer programs in computer systems under operation are published regardless of the scale of the error. If all patches published are applied to the corresponding program, level down of the program due to the patches may occur. To prevent this level down due to patches, a person with high skill extracts patches to be applied from information on the patches published.

Furthermore, there are techniques performing the procedure described below. When the system is under operation, the numbers of program execution are recorded in a control table. When a patch is received, the number of execution of a computer program having the same function name of the patch is obtained from the control table. If the number of execution of the program is equal to or higher than a predetermined number, the patch is extracted as a patch to be applied. A related-art example is described in Japanese Laid-open Patent Publication No. 2000-10766.

However, conventional techniques for applying patches had a problem in that it is difficult to determine if the patches are to be applied. To cite an example, when a person extracts patches to be applied, a person with low skill does not determine if the patches are to be applied although a person with high skill can extract adequate patches. Furthermore, even for a person with high skill, it is difficult to consider how the patches are combined to extract adequate patches.

To cite another example, in the case of techniques using the numbers of executions of programs, the numbers of executions are counted regardless of what parts of the programs ran. Therefore, it is difficult to determine from these counts if the patches are to be applied for the system of the user.

### SUMMARY

According to an aspect of an embodiment, an information processing apparatus includes a processor and a memory. The processor executes, when there is a modified part in a computer program under operation and the modified part has been executed, applying a provisional modification program incorporating processing of counting the number of times the modified part has been executed to the computer program under operation. The processor executes determining whether a count indicating the number of times the modified part has been executed is counted up at a predetermined timing as a result that the provisional modification program has been applied. And the processor executes, when the count has been determined to be counted up at the determining, replacing the provisional modification program including the modified part determined to be counted up with a post-modification program including the modified part having been modified.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of a system performing patch application determination according to an embodiment;

FIG. 2 is a diagram illustrating a specific example of patch creation performed by a patch creator;

FIG. 3 is a diagram illustrating an example of data structure of a counter DB according to the embodiment;

FIG. 4 is a flowchart illustrating the procedure of the patch creation according to the embodiment;

FIG. 5 is a flowchart illustrating the procedure of patch publication according to the embodiment;

FIG. 6 is a flowchart illustrating the procedure of the patch application determination according to the embodiment;

FIG. 7 is a flowchart illustrating the procedure of creating the counter DB according to the embodiment;

FIG. 8 is a flowchart illustrating the procedure of counter processing according to the embodiment;

FIG. 9 is a flowchart illustrating the procedure of patch data application according to the embodiment;

FIG. 10 is a diagram illustrating a specific example of the content of patch data;

FIG. 11 is a diagram illustrating the state of the counter DB;

FIG. 12 is a diagram illustrating the state of the counter DB when there are two objects including modification with respect to one patch ID; and

FIG. 13 is a diagram illustrating a computer executing a patch application determination program.

### DESCRIPTION OF EMBODIMENT

Preferred embodiments of the present invention will be explained with reference to accompanying drawings. In the embodiment described below, a computer program that had a problem and so underwent modification is called “patch”. Furthermore, the present invention is not limited by the embodiment.

Configuration of Computer System According to Embodiment

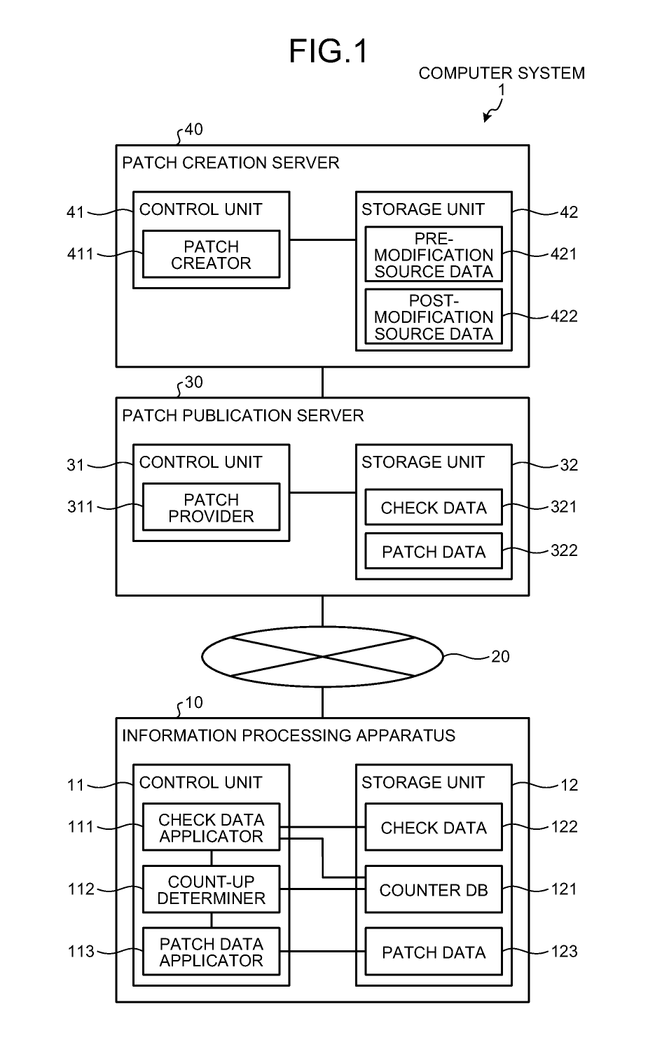

FIG. 1 is a functional block diagram illustrating a configuration of a system performing patch application determination according to the embodiment. As illustrated in FIG. 1, a computer system 1 includes an information processing apparatus 10, a network 20, a patch publication server 30, and a patch creation server 40.

The patch creation server 40 is a server creating a patch. In other words, when an error is generated in any part of a computer program under operation, the patch creation server 40 creates patch data in which the erroneous part of the program has been modified. The patch creation server 40 also creates check data for determining if the patch data is to be applied in the information processing apparatus 10 described later to which the patch is to be applied. The check data refers to data in which counter processing is incorporated into the modified part of the patch data. This counter processing counts up the counts corresponding to a patch identification (ID) given as identification information of the patch data upon being called. Specifically, when the information processing apparatus 10 executes check data and runs the counter processing in the check data, the counter processing counts up the counts corresponding to the patch ID of the patch data delivered as a parameter. The counter processing is prepared as a part in a library created in advance, for example.

The patch creation server 40 includes a control unit 41 and a storage unit 42. The control unit 41 includes a patch creator 411. The storage unit 42 includes pre-modification source data 421 and post-modification source data 422. The pre-modification source data 421 indicates a source file of the program under operation. The post-modification source data 422 indicates a source file of the patch data in which the erroneous part of the program has been modified, that is, a source file of the program after modification. The patch creator 411 adds the modified part to the erroneous part of the pre-modification source data 421 to create the post-modification source data 422. Thereafter, the patch creator 411 compiles the post-modification source data 422 and further operates a patch creation tool that is a tool for creating patch-related data to create patch data. The patch creator 411 also compares the pre-modification source data 421 and the post-modification source data 422 to search for the modified part, which is the difference. Thereafter, the patch creator 411 adds counter processing to the modified part searched by the pre-modification source data 421. The patch creator 411 then compiles source data to which the counter processing is added and further operates the patch creation tool to create check data.

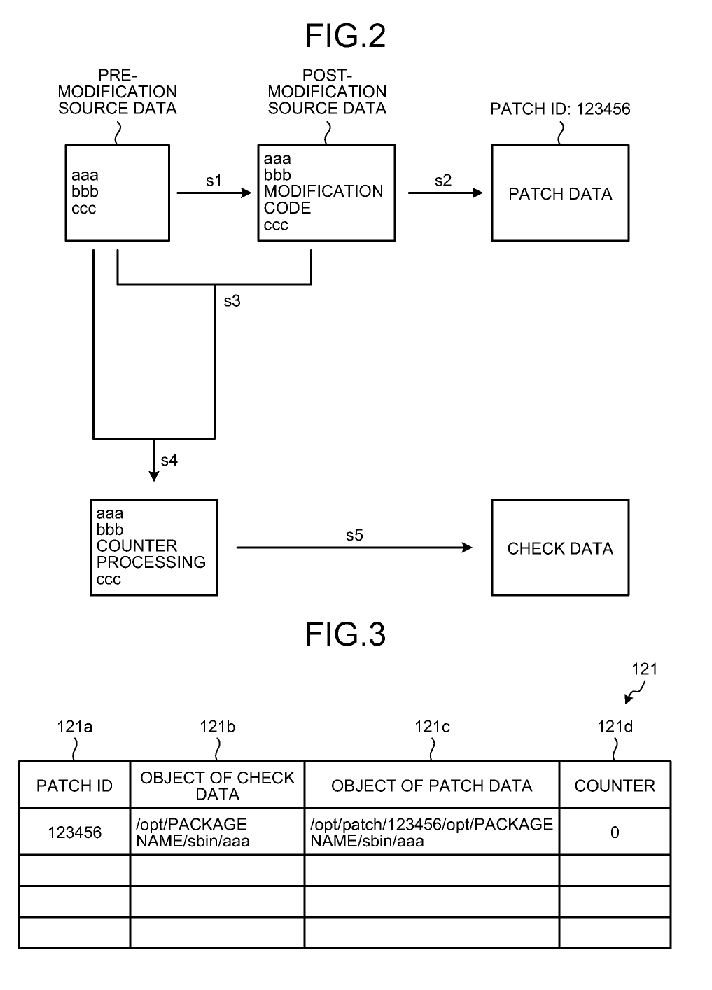

A specific example of patch creation performed by the patch creator 411 is now described with reference to FIG. 2. FIG. 2 is a diagram illustrating a specific example of patch creation performed by a patch creator. As illustrated in FIG. 2, in the pre-modification source data 421, source codes of aaa, bbb, and ccc are written. Suppose an error occurs in the part of bbb. The patch creator 411 adds a modification code between bbb and ccc which are erroneous parts in the pre-modification source data 421 and creates the post-modification source data 422 (s1). The patch creator 411 then compiles the post-modification source data 422 thus created and further operates the patch creation tool to create patch data (s2). Into the patch data, “123456”, for example, is written as a patch ID.

Next, the patch creator 411 compares the pre-modification source data 421 and the post-modification source data 422 (s3) to explore for the modified part, which is the difference. In this case, the patch creator 411 considers the modified part as in between bbb and ccc based on the exploration because the modification code has been added to between bbb and ccc. Thereafter, the patch creator 411 adds counter processing to the modified part of the pre-modification source data 421 (s4). At this point, the patch creator 411 writes the patch ID of the patch data as a parameter of the counter processing. Thereafter, the patch creator 411 compiles the source data created by adding the counter processing to the pre-modification source data 421 and further operates the patch creation tool to create check data (s5).

Back to FIG. 1, the patch creator 411 registers the patch data and the check data thus created on the patch publication server 30.

The patch publication server 30 is a server for publishing patches. The patch publication server 30 includes a control unit 31 and a storage unit 32. The control unit 31 includes a patch provider 311. The storage unit 32 includes check data 321 and patch data 322. The check data 321 represents check data registered by the patch creator 411. The patch data 322 represents patch data registered by the patch creator 411. The patch publication server 30 collectively manages the patch data 322 and the check data 321 registered by the patch creation server 40. When the patch publication server 30 acquires a request to download the patch data 322 from the information processing apparatus 10, the patch publication server 30 also provides the requestor with the patch data 322 thus requested and the check data 321 corresponding to the patch data 322.

When there is a modified part in the program under operation, the information processing apparatus 10 performs normal operation using the check data into which the counter processing has been incorporated instead of applying the patch data and counts up the count when the part to be modified in the check data has been modified. The information processing apparatus 10 then determines if the count has been counted up at a predetermined timing and applies the original patch data with respect to the modification of which the count has been counted up. Specifically, if the modified part has been modified even once, the information processing apparatus 10 replaces the check data for the modified part for which the count-up has been detected with the original patch data at the timing of power-off or power-on, for example.

The information processing apparatus 10 is connected to the patch publication server 30 via a network 20. The information processing apparatus 10 also includes a control unit 11 and a storage unit 12. The control unit 11 includes a check data applicator 111, a count-up determiner 112 determining count-up, and a patch data applicator 113 applying a patch counted up when the power of the information processing apparatus 10 is turned on or off, for example. The function of the control unit 11 can be achieved by an integrated circuit such as an application specific integrated circuit (ASIC) or a field programmable gate array (FPGA). The function of the control unit 11 also can be achieved by a predetermined program functioning a central processing unit (CPU).

The storage unit 12 is a storage device and may be a semiconductor memory element such as a random access memory (RAM) or a flash memory, a hard disc, or an optical disc. The storage unit 12 also includes a counter DB 121, check data 122, and patch data 123. The counter DB 121 stores therein a counter used for determining if the modified part in patch data has been passed for each piece of patch data. The detailed explanation of the counter DB 121 will be described later.

The check data 122 is an object in which counter processing is incorporated into the modified part of the patch data. The patch data 123 is an object in which an erroneous part in the program under operation has been modified. The check data 122 and the patch data 123 are provided from the patch publication server 30 based on a request to download the patch data 123.

When there is a modified part in the program under operation, the check data applicator 111 applies a provisional modification program into which counter processing counting up the count when the modified part has been passed is incorporated, that is, the check data 122 to the program under operation. For example, when there is a modified part in the program under operation, the check data applicator 111 outputs a request to download patch data 322 and check data 321 corresponding to the program including the modification to the patch publication server 30. Thereafter, the check data applicator 111 is provided with the patch data 322 and the check data 321 meeting the request from the patch publication server 30. The check data applicator 111 then arranges the check data 321 thus provided on an arrangement position of the object to be executed originally and arranges the patch data 322 thus provided on an arrangement position distinguishable for each piece of patch data 322. To cite an example, the check data applicator 111 arranges the patch data 322 on an arrangement position in a level higher than the arrangement position of the object to be executed originally to which the patch ID has been added.

The check data applicator 111 also creates the counter DB 121 related to the patch data 123 thus provided. The data structure of the counter DB 121 is now described with reference to FIG. 3. FIG. 3 is a diagram illustrating an example of data structure of a counter DB according to the embodiment. As illustrated in FIG. 3, the counter DB 121 stores therein an object 121b of check data, an object 121c of patch data, and a counter 121d in an associated manner for each patch ID 121a. In a patch ID 121a, the identifier of the patch data 123 is stored. In an object 121b of check data, the arrangement position of the check data 122 is stored. In an object 121c of patch data, the arrangement position of the patch data 123 is stored. For example, when the value of the patch ID is “123456”, the counter DB 121 stores therein “/opt/package name/sbin/aaa” as the arrangement position of the object of check data, and stores therein “/opt/patch/123456/opt/package name/sbin/aaa” as the arrangement position of the object of patch data. In other words, the arrangement position of the object of patch data is an arrangement position in a level higher than the arrangement position of the object of check data to which the patch ID “123456” has been added. The counter DB 121 also stores therein 0 which is the initial value as the value of the counter 121d. The check data applicator 111 may create the counter DB 121 on the arrangement position of the patch data 123 or on an arrangement position dedicated for creating the counter DB 121.

Back to FIG. 1, if the modified part in the check data 122 has been passed when the program is executed in the information processing apparatus 10, the check data applicator 111 causes the counter processing incorporated in the modified part to increment the value of the counter 121d in the counter DB 121. The procedure of the counter processing will be described later.

The count-up determiner 112 determines if the count has been counted up at a predetermined timing based on the result of execution of the check data 122 performed by the check data applicator 111. For example, the count-up determiner 112 sequentially reads out the value of the counter 121d in the counter DB 121 at the timing of power-off or power-on of the information processing apparatus 10 and determines if the value of the counter 121d thus read out is “0”.

When the count-up determiner 112 has determined that the count had been counted up, the patch data applicator 113 replaces the check data 122 with the modified program in which the part to be modified has been modified, that is, the patch data 123. For example, when the value of the counter 121d in the counter DB 121 has been determined not to be “0”, the patch data applicator 113 reads out the patch ID in the row determined not to be “0” from the counter DB 121. The patch data applicator 113 then copies the object of patch data in the same row as the patch ID thus read out onto the arrangement position of the object of check data. In other words, the patch data applicator 113 replaces the object of check data under operation with the patch data which is the modified program. The patch data applicator 113 further deletes the row of the patch ID targeted for replacement from the counter DB 121.

Procedure of Patch Application Determination According to the Embodiment

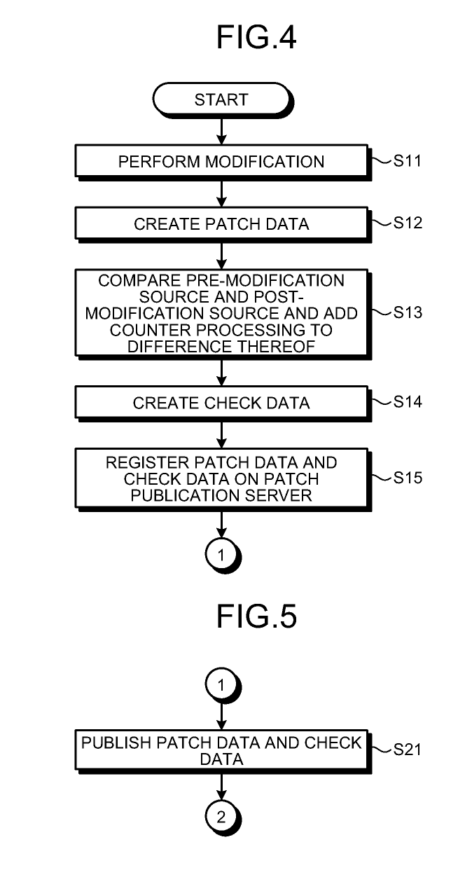

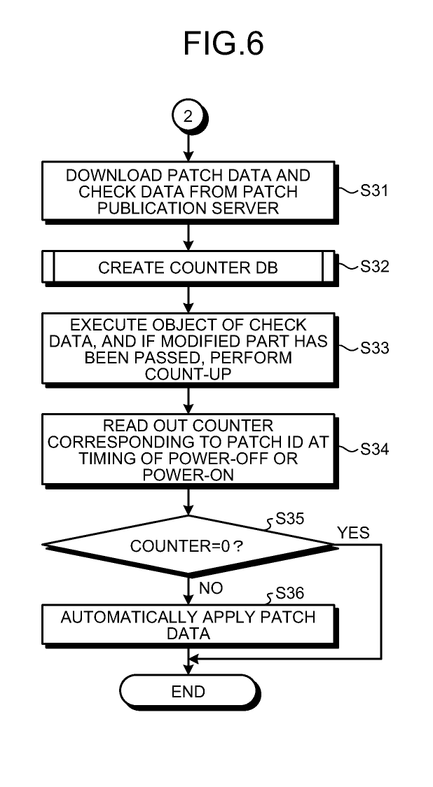

Next, the procedure of the patch application determination according to the embodiment is described with reference to FIGS. 4 to 6. FIG. 4 is a flowchart illustrating the procedure of the patch creation according to the embodiment. FIG. 5 is a flowchart illustrating the procedure of patch publication according to the embodiment. FIG. 6 is a flowchart illustrating the procedure of the patch application determination according to the embodiment. It is assumed that an error has occurred in any part of a computer program under operation as an example.

When an error has occurred in a computer program under operation, in the patch creation server 40, the patch creator 411 performs modification of the pre-modification source data 421 which is the source file of the program in which the error has occurred (Step S11). The patch creator 411 then adds the modified part to the erroneous part of the pre-modification source data 421 to create the post-modification source data 422. Thereafter, the patch creator 411 compiles the post-modification source data 422 thus created and further operates the patch creation tool to create patch data (Step S12).

Next, the patch creator 411 compares the pre-modification source data 421 and the post-modification source data 422 and adds the counter processing to the modified part, which is the difference (Step S13). The patch creator 411 then compiles the source data to which the counter processing has been added and further operates the patch creation tool to create the check data (Step S14).

Thereafter, the patch creator 411 registers the patch data and the check data thus created to the patch publication server 30 (Step S15).

Once the patch data 322 and the check data 321 have been registered by the patch creation server 40, the patch publication server 30 publishes the patch data 322 and the check data 321 thus registered (Step S21).

Next, in the information processing apparatus 10, the check data applicator 111 downloads the patch data 322 and the check data 321 related to the program in which the error has occurred from the patch publication server 30 (Step S31). The check data applicator 111 then arranges the check data 122 thus downloaded on an arrangement position of the object to be executed originally and arranges the patch data 123 thus downloaded on an arrangement position distinguishable for each piece of the patch data.

Thereafter, the check data applicator 111 creates the counter DB 121 corresponding to the patch ID of the patch data 123 thus downloaded (Step S32). The procedure of the counter DB 121 will be described later.

When the modified part in the check data 122 has been passed during execution of the program in the information processing apparatus 10, the counter for the modified part in the check data that has been passed performs count-up (Step S33). In other words, when the modified part in the check data 122 has been passed, the check data applicator 111 causes the counter processing incorporated into the modified part to increment the value of the counter 121d in the counter DB 121. The counter processing is provided with the patch ID of the patch data as a parameter. Furthermore, the counter processing performs one addition of the value of the counter 121d corresponding to the patch ID thus provided with respect to the counter DB 121.

Thereafter, the count-up determiner 112 reads out the value of the counter 121d corresponding to the patch ID from the counter DB 121 at the timing of power-off or power-on (Step S34). The count-up determiner 112 then determines if the value of the counter 121d thus read out is 0 (Step S35). When the value of the counter 121d has been determined to be 0 (Yes at Step S35), the count has not been counted up. Accordingly, the count-up determiner 112 determines that application of the patch data will not operate the modified part, and the patch application determination processing is ended.

In contrast, when the value of the counter 121d has been determined not to be “0” (No at Step S35), the patch data applicator 113 automatically applies the patch data 123 because the count has been counted up (Step S36). In other words, the patch data applicator 113 replaces the check data 122 that has been operated with the patch data 123. The application procedure of the patch data will be described later.

Procedure of Creating Counter DB According to Embodiment

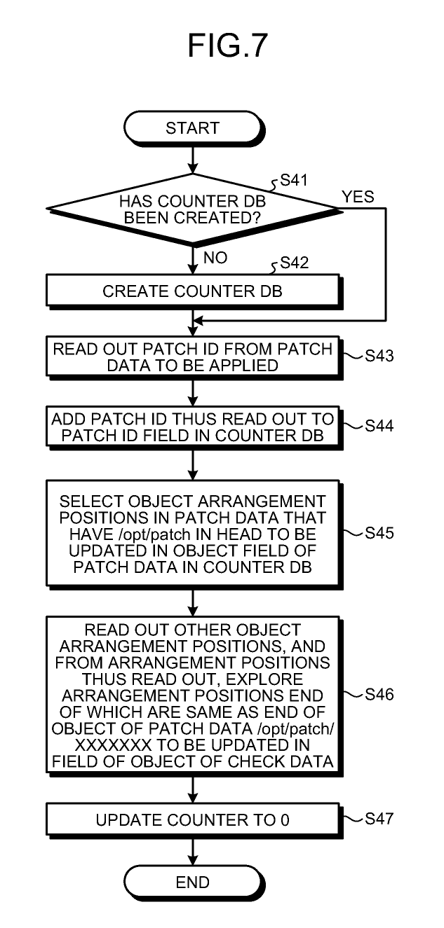

Next, the processing procedure of Step S32 illustrated in FIG. 6 is described with reference to FIG. 7. FIG. 7 is a flowchart illustrating the procedure of creating a counter DB according to the embodiment. In the example illustrated in FIG. 7, the counter DB 121 is created based on the arrangement position of the patch ID and the object written in the patch data 123.

Firstly, the check data applicator 111 determines if the counter DB 121 has been created (Step S41). When the check data applicator 111 has determined that the counter DB 121 had not been created (No at Step S41), the check data applicator 111 creates an empty counter DB 121 (Step S42) and moves to Step S43. In contrast, the check data applicator 111 determines that the counter DB 121 has been created (Yes at Step S41), the check data applicator 111 moves to Step S43.

Next, the check data applicator 111 reads out the patch ID from the patch data 123 to be applied (Step S43). The check data applicator 111 adds the patch ID thus read out to the patch ID field in the counter DB 121 (Step S44).

Thereafter, the check data applicator 111 selects the first arrangement position that has “/opt/patch” attached thereto from arrangement positions of objects in the patch data 123 to be updated in the object field of patch data in the counter DB 121 (Step S45).

The check data applicator 111 further reads out other arrangement positions from arrangement positions of objects in the patch data 123. The check data applicator 111 then explores arrangement positions that are the same as those under “/opt/patch/xxxxxx” in arrangement positions of objects of patch data from the arrangement positions thus read out. The check data applicator 111 then updates the arrangement position thus explored in the object field of check data in the counter DB 121 (Step S46).

Thereafter, the check data applicator 111 then updates the initial value of 0 in the counter field in the counter DB 121 (Step S47).

Procedure of Counter Processing according to Embodiment

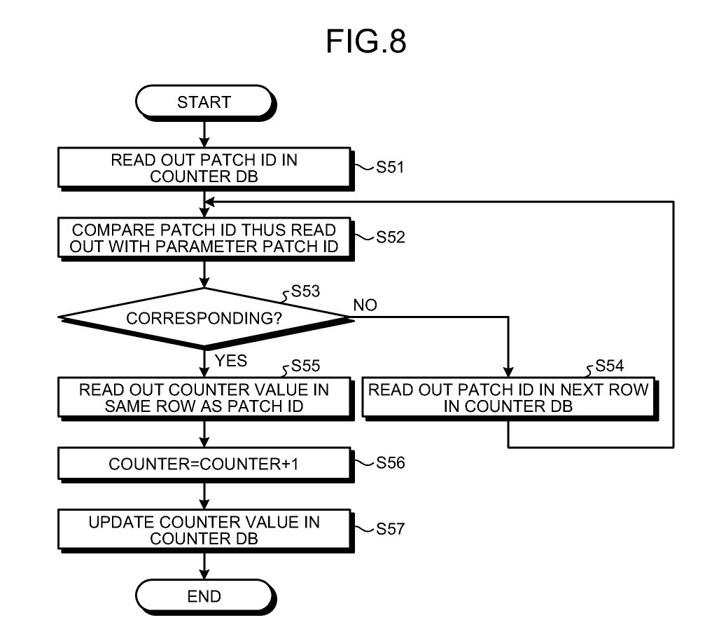

Next, the procedure of counter processing at Step S33 illustrated in FIG. 6 is described with reference to FIG. 8. FIG. 8 is a flowchart illustrating the procedure of counter processing according to the embodiment. The description below is based on the assumption that a patch ID is given as the parameter.

Firstly, the counter processing reads out a patch ID in the counter DB 121 (Step S51). The counter processing then compares the patch ID read out from the counter DB 121 and the patch ID given as the parameter (Step S52). The counter processing then determines if the patch ID thus read out corresponds to the patch ID given as the parameter (Step S53).

When the counter processing has determined that the patch ID thus read out does not correspond to the patch ID given as the parameter (No at Step S53), the counter processing reads out the patch ID on the next row in the counter DB 121 (Step S54) and moves to Step S52.

In contrast, when the counter processing has determined that the patch ID thus read out corresponds to the patch ID given as the parameter (Yes at Step S53), the counter processing reads out the counter value that is in the same row as the patch ID determined to be corresponding (Step S55). The counter processing then adds the counter value thus read out once to count up the count (Step S56). The counter processing then updates the counter value of the counter DB 121 to the value obtained by the addition (Step S57).

Procedure of Patch Data Application according to Embodiment

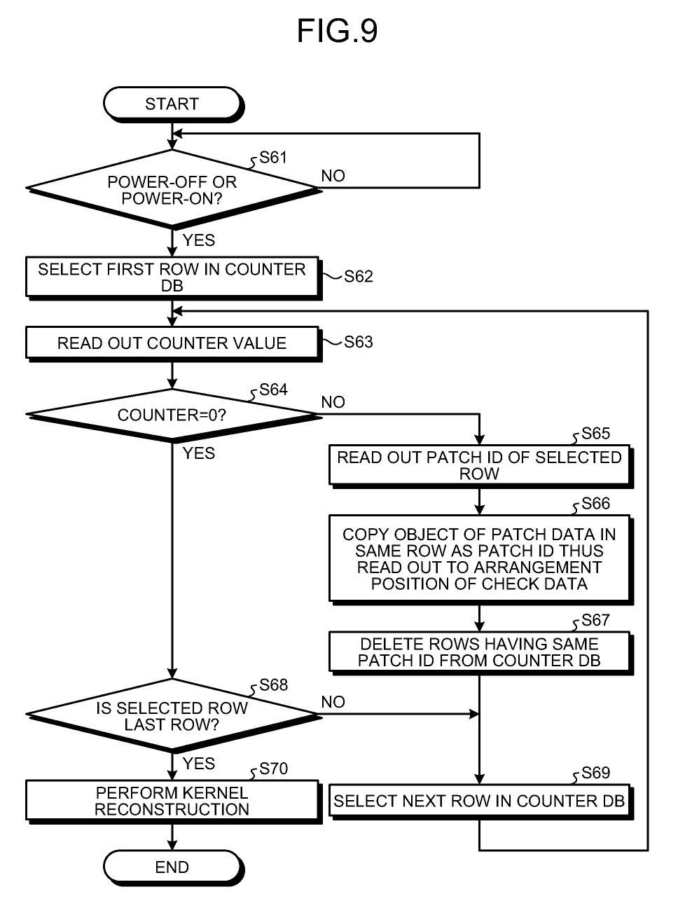

Next, procedure of patch data application at Step S34 to Step S36 illustrated in FIG. 6 is described with reference to FIG. 9. FIG. 9 is a flowchart illustrating the procedure of patch data application according to the embodiment.

Firstly, the count-up determiner 112 determines if the power is turned off or turned on (Step S61). When the count-up determiner 112 has determined that the power is not turned off or turned on (No at Step S61), the count-up determiner 112 repeats determination until the power is turned off or turned on.

In contrast, when the count-up determiner 112 has determined that the power is turned off or turned on (Yes at Step S61), the count-up determiner 112 selects the first row in the counter DB 121 (Step S62). The count-up determiner 112 reads out the counter value from the first row thus selected (Step S63).

Next, the count-up determiner 112 determines if the counter value thus read out is 0 (Step S64). When the count-up determiner 112 has determined that the counter value is not 0 (No at Step S64), the patch data applicator 113 reads out the patch ID in the selected row (Step S65). The patch data applicator 113 then copies the object of patch data that is in the same row as the patch ID thus read out in the arrangement position of check data (Step S66). In other words, the patch data applicator 113 replaces the check data 122 under operation with the patch data 123.

Thereafter, the patch data applicator 113 deletes the rows of the patch IDs that are the same as the patch ID read out from the counter DB 121 (Step S67). The patch data applicator 113 then moves to Step S69 to select the next row.

In contrast, when the count-up determiner 112 has determined that the counter value is 0 (Yes at Step S64), the patch data applicator 113 determines if the selected row is the last row (Step S68). When the patch data applicator 113 has determined that the selected row is not the last row (No at Step S68), the count-up determiner 112 selects the next row in the counter DB 121 (Step S69) and moves to Step S63.

In contrast, the patch data applicator 113 has determined that the selected row is the last row (Yes at Step S68), the patch data applicator 113 performs kernel reconstruction if the patch data 123 is data related to the operating system (OS) (Step S70). If the patch data 123 is not data related to the OS, there is no need to perform kernel construction.

Specific Example of Applying Patch Data to Currently Operated Object

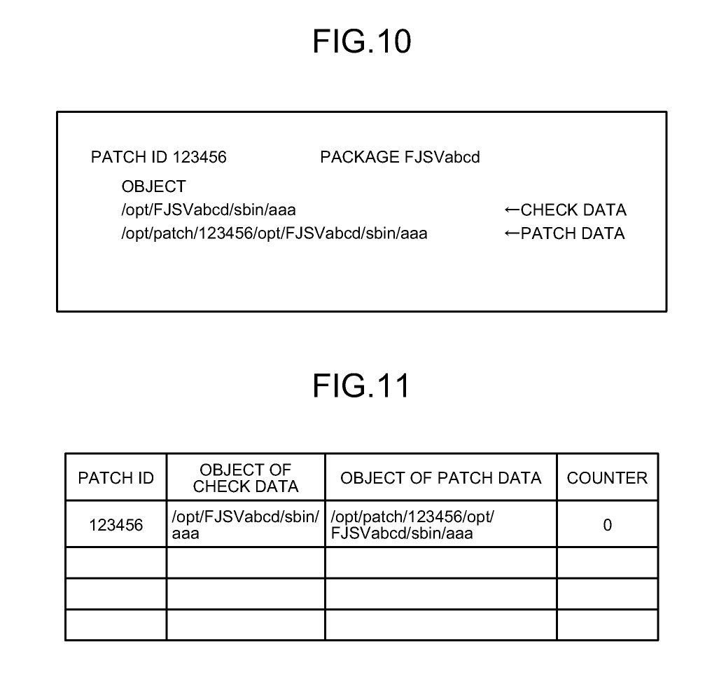

A specific example of applying patch data of which the patch ID value is “123456” to the currently operated object is now described with reference to FIGS. 10 and 11. FIG. 10 is a diagram illustrating a specific example of the content of patch data. FIG. 11 is a diagram illustrating the state of the counter DB. The description below is based on the assumption that the currently operated object is arranged at “/opt/FJSVabcd/sbin/aaa”.

As illustrated in FIG. 10, in the patch data 123, “123456” is written as the value of the patch ID and “FJSVabcd” is written as the name of the package. As the arrangement position of the object, the arrangement positions of the check data 122 and the patch data 123 are written. In the arrangement position of the check data 122, “/opt/FJSVabcd/sbin/aaa” is written in which “aaa” is the object name of the check data 122.

In the arrangement position of the patch data 123, “opt/patch/123456/opt/FJSVabcd/sbin/aaa” is written in which “aaa” is the object name of the patch data 123 In other words, the arrangement position of the patch data 123 is an arrangement position of “/opt/123456/opt” under which the arrangement position of the object to be originally executed is added.

When the information processing apparatus 10 is provided with the patch data 123 and the check data 122 as described above, the check data applicator 111 creates the counter DB 121 related to the patch ID “123456” written in the patch data 123. As illustrated in FIG. 11, in the state of the counter DB 121 immediately after the creation, the patch ID value is “123456” and “/opt/FJSVabcd/sbin/aaa” is stored as the arrangement position of the object of the check data 122. “/opt/patch/123456/opt/FJSVabcd/sbin/aaa” is stored as the arrangement position of the object of the patch data 123 and the initial value of 0 is stored as the value of the counter 121d.

In the state described above, the check data applicator 111 executes the object “aaa” being the check data 122, and adds the counter value of the counter DB 121 once by performing counter processing when the modified part in the object “aaa” has been passed. Thereafter, the patch data applicator 113 checks the value of the counter corresponding to the patch ID “123456” stored in the counter DB 121 at the timing of power-off or power-on.

When the value of the counter corresponding to the patch ID “123456” is 0 as illustrated in FIG. 11, the patch data applicator 113 does not apply the patch data 123 because the modified part is not passed even if the patch ID “123456” is modified. However, when the value of the counter corresponding to the patch ID “123456” is not 0, the patch data applicator 113 applies the patch data 123 because the modified part is passed if the patch ID “123456” is modified. In other words, the patch data applicator 113 replaces the object of the check data 122 “aaa” with the object of the patch data 123 “aaa”.

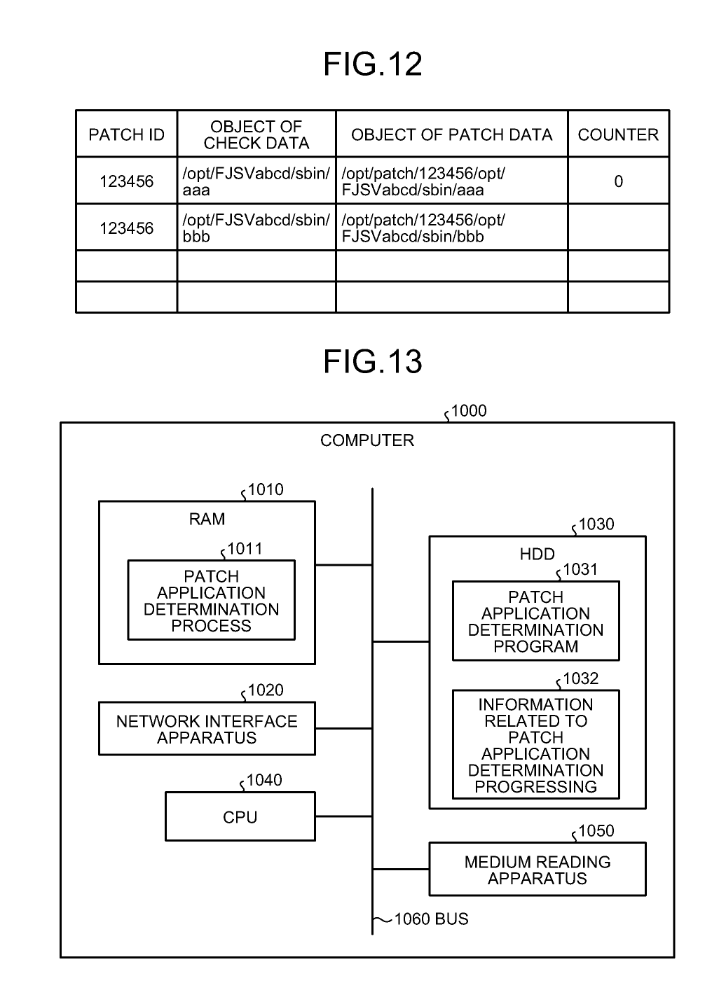

In the embodiment described above, a case has been described where there is one object including modification with respect to one patch ID. However, even if there are two or more objects including modification with respect to one patch ID, the patch application determination processing is not different. The state of the counter DB 121 when there are two objects including modification with respect to one patch ID will be described with reference to FIG. 12. FIG. 12 is a diagram illustrating the state of the counter DB when there are two objects including modification with respect to one patch ID.

As illustrated in FIG. 12, in the state of the counter DB 121 immediately after the creation, the patch ID value is “123456” in which there are two objects including modification which are “aaa” and “bbb”. Furthermore, even if there are two objects including modification with respect to the patch ID “123456”, only one counter is used. Therefore, the check data applicator 111 adds the value of one counter once if at least one of “aaa” and “bbb” passes the modified part.

Now, suppose the value of the counter corresponding to the patch ID “123456” is 0 as illustrated in FIG. 12. In this case, the patch data applicator 113 does not apply the object “aaa” or the object “bbb” because the modified part is not passed even if the patch ID “123456” is modified. However, the patch data applicator 113 replaces the object of the check data 122 “aaa” with the object of the patch data 123 “aaa” when the counter value is not 0. The patch data applicator 113 further replaces the object of the check data 122 “bbb” with the object of the patch data 123 “bbb”.

Effects of Embodiment

According to the embodiment described above, when there is a modified part in the program under operation, the check data applicator 111 in the information processing apparatus 10 incorporates the check data 122, into which the processing counting up the count when the modified part has been passed is incorporated, into the program under operation. Thereafter, the count-up determiner 112 determines if the check data 122 has been executed with the program executed in the information processing apparatus 10 at a predetermined timing based on if the counter DB has been counted up or not. Furthermore, when the count-up determiner 112 has determined that there is a patch (check data) application part of which the count had been counted up, the patch data applicator 113 replaces the check data 122 of which the count has been counted up with the modified program in which the modified part has been modified, that is, the patch data 123. With this configuration, the information processing apparatus 10 executes the check data 122 into which the processing counting up the count when the modified part has been passed is incorporated, and therefore can use the count to determine if the modified part has been passed. Accordingly, the information processing apparatus 10 can apply the patch data 123 when the modified part has been passed, and therefore can appropriately determine if the patch data 123 is to be applied.

Furthermore, according to the embodiment described above, when the count-up determiner 112 has determined that the count had not been counted up, the patch data applicator 113 does not replace the check data 122 with the patch data 123. With this configuration, when the count has not been counted up, that is, when the modified part has not been passed, the patch data applicator 113 does not replace the check data 122 with the patch data 123. Accordingly, the patch data applicator 113 can prevent occurrence of level down due to the patch data 123 being applied even in the cases where the patch data 123 does not have to be applied.

Furthermore, according to the embodiment described above, the count-up determiner 112 determines if the count has been counted up at the timing when the information processing apparatus 10 is stopped or activated. With this configuration, because the count-up determiner 112 uses the timing when the determination whether the count has been counted up does not hinder operation of the program, the count-up determiner 112 can effectively replace with the patch data 123 if the count has been counted up.

In the embodiment described above, when there is a modified part in the program under operation, the check data applicator 111 applies the check data 122, into which the counting processing counting the number of modifications when modification has been executed is incorporated, to the program under operation. Furthermore, when the counter processing in the check data 122 runs, the counter processing counts up the count corresponding to the patch ID of the patch data 123 delivered as a parameter. However, the counter processing is not limited to this and may count down the count corresponding to the patch ID of the patch data 123 delivered as a parameter. In this case, when the count has been determined to be counted down by the count-up determiner 112, the patch data applicator 113 may replace the check data 122 with the patch data 123.

Computer Programs and Other Terms

The information processing apparatus 10 can be materialized with various functions such as the control unit 11 and the storage unit 12 described above mounted on an information processing apparatus such as a known personal computer or a work station.

Each component of the devices illustrated does not need to be physically configured as illustrated. In other words, the specific aspects of separation and integration of each device is not limited to those illustrated and all or part of the aspects may be separated or integrated functionally or physically in optional units in accordance with various loads, use conditions, and other factors to configure each component. For example, the count-up determiner 112 and the patch data applicator 113 may be integrated as one part. In contrast, the check data applicator 111 may be separated into a download unit downloading the check data 321 and the patch data 322 and the check data applicator 111 executing the check data 321 thus downloaded. Furthermore, the storage unit 12 of the counter DB 121, for example, may be connected to the information processing apparatus 10 as an external device via a network.

Various processing described in the embodiment above can be materialized with a computer program prepared in advance executed in a computer such as a personal computer or a work station. Described below with reference to FIG. 13 is an example of a computer executing a patch application determination program including functions similar to those of the control unit 11 in the information processing apparatus 10 illustrated in FIG. 1.

FIG. 13 is a diagram illustrating a computer executing a patch application determination program. As illustrated in FIG. 13, a computer 1000 is the same as the information processing apparatus 10 illustrated in FIG. 1 and includes a RAM 1010, a network interface apparatus 1020, an HDD 1030, a CPU 1040, a medium reading apparatus 1050, and a bus 1060. The RAM 1010, the network interface apparatus 1020, the HDD 1030, the CPU 1040, and the medium reading apparatus 1050 are connected by the bus 1060. The patch creation server 40 and the patch publication server 30 illustrated in FIG. 1 also can be materialized by an information processing apparatus having the same structure as in FIG. 13.

The HDD 1030 stores therein a patch application determination program 1031 having the same function as the control unit 11 illustrated in FIG. 1. The HDD 1030 also stores therein information related to patch application determination processing 1032 corresponding to the counter DB 121, the check data 122, and the patch data 123 illustrated in FIG. 1.

Furthermore, the CPU 1040 reads out the patch application determination program 1031 from the HDD 1030 and decompress the patch application determination program 1031 thus read out into the RAM 1010, thereby causing the patch application determination program 1031 to function as a patch application determination process 1011. The patch application determination process 1011 then decompresses information read out from the information related to the patch application determination processing 1032 and other information in the region allocated to the patch application determination process 1011 in the RAM 1010 as appropriate to perform various data processing based on the data thus decompressed, for example.

The medium reading apparatus 1050 reads out the patch application determination program 1031 from a medium storing therein the patch application determination program 1031, for example, even if the patch application determination program 1031 is not stored in the HDD 1030. The medium reading apparatus 1050 includes a CD-ROM and an optical disc device, for example.

The network interface apparatus 1020 is an apparatus that is connected to an external device via a network. The network interface apparatus 1020 may be an apparatus supporting wired systems or an apparatus supporting wireless systems.

The patch application determination program 1031 may be stored in other apparatus such as a computer (or a server) that is connected to the computer 1000 via a communication line such as a public line, the Internet, a LAN, a wide area network (WAN). In such a case, the computer 1000 reads out the patch application determination program 1031 from the other apparatus such as a computer via the network interface apparatus 1020.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

According to an aspect of an information processing apparatus disclosed in the subject application, determination whether patches are to be applied can be made appropriately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a processor; and
a memory, wherein the processor executes:
when there is a modified part in a computer program under operation and the modified part has been executed, applying a provisional modification program incorporating processing of counting the number of times the modified part has been executed to the computer program under operation;
determining whether a count indicating the number of times the modified part has been executed is counted up at a predetermined timing as a result that the provisional modification program has been applied; and
when the count has been determined to be counted up at the determining, replacing the provisional modification program including the modified part determined to be counted up with a post-modification program including the modified part having been modified.

2. The information processing apparatus according to claim 1, wherein the replacing includes not replacing the provisional modification program with the post-modification program when the count has been determined not to be counted up at the determining.

3. The information processing apparatus according to claim 1, wherein the determining includes determining whether the count has been counted up at the timing when the information processing apparatus is stopped or activated.

4. A non-transitory computer-readable recording medium having stored therein a program for causing a computer to execute a modification application determination process comprising:
when there is a modified part in a computer program under operation and the modified part has been executed, applying a provisional modification program incorporating processing of counting the number of times the modified part has been executed to the computer program under operation;
determining whether a count indicating the number of times the modified part has been executed is counted up at a predetermined timing as a result that the provisional modification program has been applied; and
when the count has been determined to be counted up at the determining, replacing the provisional modification program including the modified part determined to be counted up with a post-modification program including the modified part having been modified.

5. A method for determining whether a modified program is to be applied, the method comprising:
when there is a modified part in a computer program under operation and the modified part has been executed, applying a provisional modification program incorporating processing of counting the number of times the modified part has been executed to the computer program under operation using a processor;
determining whether a count indicating the number of times the modified part has been executed is counted up at a predetermined timing as a result that the provisional modification program has been applied using the processor; and
when the count has been determined to be counted up at the determining, replacing the provisional modification program including the modified part determined to be counted up with a post-modification program including the modified part having been modified using the processor.
